(19) United States
(12) Patent Application Publication
(10) Pub. No.: US 2005/0141850 A1
(43) Pub. Date: Jun. 30, 2005

(54) Method and apparatus for displaying a received stream of audiovisual information

(76) Inventors: Johan Hendrik Antoon Gelissen, Eindhoven (NL); Keith Baker, Eindhoven (NL)

Correspondence Address: Philips Electronics North America Corporation, P O Box 3001, Briarcliff Manor, NY, 10510, US

(21) Appl. No.: 10/498,642

(22) PCT Filed: Dec. 3, 2002
(86) PCT No.: PCT/IB02/05103

(30) Foreign Application Priority Data
Dec. 17, 2001 (EP) 01204935.9

(51) Int. Cl. H04N 5/76; H04N 5/781

(52) U.S. Cl. 386/46; 386/125

(57) ABSTRACT

The invention relates to a method and apparatus (110) for receiving and displaying a stream of audiovisual information (200). During display of the stream of audiovisual information (200), the display may be interrupted by an application (220). This causes a user to miss part of the audiovisual information (200). It is therefore proposed to store the audiovisual information (200) during the application (220) and present the missed content (202) to the user after the interruption. The storage is automatically triggered by the start of the application (220). However, this causes a delay in the display of the audiovisual information (200). The user is offered the possibility to let the displayed stream of audiovisual information (210) catch up with the received audiovisual information (200). This catch-up may be performed automatically, triggered by the end of the application (220).

The invention relates to a method of displaying a received stream of audiovisual information which is interrupted at a point of interruption during display and in which the display of the stream of audiovisual information is resumed from the point of interruption after the end of the interruption.

An embodiment of such a method is known from WO 01/22729 A1. WO 01/22729 A1discloses a method of displaying a stream of audiovisual information. The display of the stream of audiovisual information can be interrupted by interactive applications such as a menu. In such a case, a point of interruption at which the stream of audiovisual information is interrupted is stored. After the interactive application, the stream of audiovisual information is displayed from the point of interruption.

The method described in WO 01/22729 A1 has the drawback that the display of the program material trails the transmission of the program material, with a unit of time which is equal to the duration of the interaction.

The invention also relates to an apparatus adapted to receive a stream of audiovisual information and to display this stream on a display device, the apparatus being further adapted to interrupt the display at a point of interruption during the display of the stream of audiovisual information, and to a resume the display of the stream of audiovisual information from the point of interruption after the end of the interruption.

It is an object of the invention to mitigate the drawbacks of the prior art.

This object is achieved with a method according to the invention, which is characterized in that, after resuming the display of the stream of audiovisual information, the stream of audiovisual information is displayed at an accelerated rate up to the point where the displayed stream of audiovisual information is synchronous with the received stream of audiovisual information, further referred to as point of synchronization.

This method has the advantage that, if the program expects the viewer to perform a quick interaction with respect to the transmission of the stream of audiovisual information, there is no backlog after the point of synchronization in the display of the audiovisual information and enables a user to react as fast as possible to events in the stream of audiovisual information.

An embodiment of the method according to the invention, in which the stream of audiovisual information is built up of consecutive frames, is characterized in that the accelerated display is effected by displaying key frames only, which are chosen on the basis of the information density in the stream of audiovisual information in the vicinity of the key frames.

This embodiment has the advantage that the segments of the stream of audiovisual information comprising much information can be displayed in a more extensive way to the user than segments of the stream of audiovisual information comprising relatively less information.

The apparatus according to the invention is characterized in that, after resuming the display of the stream of audiovisual information, the apparatus is further adapted to display the stream of audiovisual information at an accelerated rate up to the point where the display of the stream of audiovisual information is synchronous with the reception of the stream of audiovisual information, further referred to as point of synchronization.

These and other aspects of the invention are apparent from and will be elucidated with reference to the embodiments described hereinafter.

In the drawings:

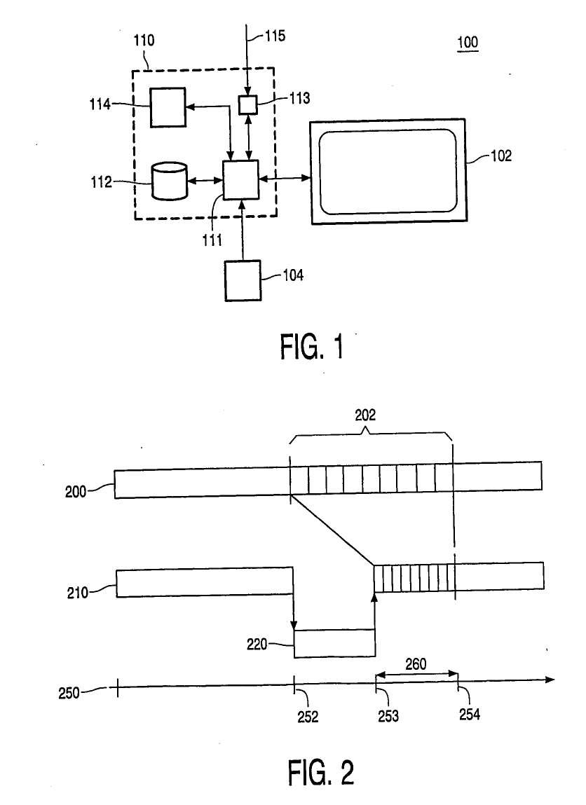

FIG. 1 shows an embodiment of the apparatus according to the invention,

FIG. 2 is an illustration to support the explanation of an embodiment of the method according to the invention.

FIG. 1 shows a system 100 as an embodiment of the invention. The system 100 is adapted to receive and display audiovisual information. The system 100 is also adapted to receive application data comprising instructions which can be performed by a processing unit and to perform said applications. The applications may be interactive applications. The system 100 comprises an apparatus 110, a display device 102 and an operating panel 104.

The apparatus 110 comprises a processing unit 111, a first memory 112, a receiver 113 and a second memory 114. This apparatus may be a set top box but also another type of dedicated apparatus for passing on and/or displaying audiovisual information. In a further embodiment of the invention, the apparatus 110 is personal computer. This does not depart from the scope of the invention.

The receiver 113 is adapted to receive an input signal 115. The input signal 115 comprises at least a stream of audiovisual information. In a further embodiment, the input signal 115 comprises a stream of audiovisual information as well as a data stream in accordance with the MHP standard in order that applications in the form of instructions which can be executed by the processing unit 111 can also be transmitted. In a further embodiment of the invention, the input signal 115 is a high-frequency signal on which at least a stream of audiovisual information is superimposed.

In a preferred embodiment, the input signal 115 is a signal in accordance with the DVB standard. In a further embodiment, the input signal 115 may be, for example, a data stream in accordance with the TCP/IP standard.

If the input signal 115 is a high-frequency signal on which the stream of audiovisual information is superimposed, the receiver 113 is also adapted to demodulate the input signal 115 and extract the stream of audiovisual information from the input signal 115.

In a further embodiment, the receiver 113 is a tuner which is known per se. If the input signal 115 comprises a stream of audiovisual information as well as a data stream, the receiver 113 is also adapted to separate the data stream and the stream of audiovisual information.

In the embodiment shown, the receiver 113 passes on the stream of audiovisual information and the data stream to the processing unit 111. The processing unit 111 is adapted to pass on the stream of audiovisual information to the display device 102 for displaying the audiovisual information. The processing unit 111 in the embodiment shown is also adapted to store the stream of audiovisual information in the first memory 112. In the presented embodiment of the invention, the first memory 112 is a hard disk drive system. However, those skilled in the art will understand that the first memory may be an opto-magnetic disc, a solid-state memory such as a flash memory or another mass storage device. The processing unit is also adapted to read a stream of audiovisual information stored in the first memory 112 and pass it on to the display device 102 in such a way that it can be displayed on the display device 102. This enables a user to check different aspects of the display by means of the operating panel 104. Said aspects may be, for example, trick play modes such as fast forward, rewind or pause. This is known per se.

In the presented embodiment, said data stream is also stored in the first memory 112.

The processing unit 111 is further adapted to perform applications comprised in said data stream. Associated images and sounds may be displayed on the display device 102. If interactive applications are concerned, the user of the system 100 may give entries to the apparatus 110 by means of the operating panel 104. If the user enters information which is used in an application at a later stage, this information is stored in the second memory 114 in this embodiment, which second memory is preferably a rapidly accessible memory such as a SRAM or DRAM.

As mentioned hereinbefore, a stream of audiovisual information and a data stream comprising instructions which can be performed by a processing unit for the relevant applications is also transmitted together with the input signal 115. In this embodiment of the invention, the stream of audiovisual information is interrupted by applications. These applications may start themselves at a given instant but the start of the applications may also be triggered by information in the stream of audiovisual information. In a further embodiment, the display device 102 shows a message to start an application if the user does not give a signal to the apparatus 110 within a predetermined time limit that the application should not be performed. This is effected by means of the operating panel 104. In the preferred embodiment of the invention, these applications are sent along with the audiovisual information in accordance with the MHP standard, and controlled in the DVB format in the preferred embodiment.

If a stream of audiovisual information is interrupted by an application, the user misses a part of the stream of audiovisual information. By storing the stream of audiovisual information in the first memory 112, reading of the stream of audiovisual information and its display on the display device 102 can be stopped if the application is started. Reading and displaying the stream of audiovisual information is subsequently resumed when the application has been ended.

However, if the stream of audiovisual information is not available in the first memory 112 but is directly passed on by the processing unit 111 from the receiver 113 to the display device 102, this possibility does not exist. A solution to this problem is now presented with reference to FIG. 2. FIG. 2 shows a received stream of audiovisual information 200, a displayed stream of audiovisual information 210, an application 220 and a time scale 250.

In the presented embodiment of the invention, said problem is solved by storing the received stream of audiovisual information 200 in the first memory 112 as from the interruption of the display of the displayed stream of audiovisual information 210 by the application at the first instant 252. After the end of the application at a second instant 253, the display of the stream of audiovisual information 210 is resumed. A part of the received stream of audiovisual information 200 stored from the first instant 252 is displayed on the display device 102. According to the invention, a stored part of the stream of audiovisual information 202 is displayed at an accelerated rate after the second instant 253 until the displayed stream of audiovisual information 210 is synchronous again with the received stream of audiovisual information 200. The point at which the displayed stream of audiovisual information 210 and the received stream of audiovisual information 200 are synchronous with each other is shown as a point of synchronization 254 in FIG. 2.

In a preferred embodiment of the invention, the duration of a synchronization period 260 is fixed. The ratio between the time required for playing the stored part 202 in the standard play mode and the predetermined synchronization period defines the playback speed of the stored part 202 in the synchronization period 260. In a further embodiment of the invention, only the ratio between the time taken for playing the stored part 202 in the standard play mode and the synchronization period is determined in advance. In this way, the synchronization period 260 is determined. A further embodiment enables the user to determine the synchronization period of his own preference.

In a preferred embodiment of the invention, the synchronization process proceeds automatically after the end of the interruption. This means that, after the end of the application, the accelerated display of the stored stream of audiovisual information 202 up to the point of synchronization 254 is started automatically. In a further embodiment of the invention, this is not effected automatically and the user is enabled to synchronize; by means of a button on the operating panel 104, the displayed stream of audiovisual information with the received stream of audiovisual information.

In a preferred embodiment of the invention, the stored part 202 is displayed on the display device 102 at a constant speed during the synchronization period 260. In a further embodiment of the invention, the display speed of the stored part 202 is determined by the information density of portions of the stored part. If a segment of the stored part 202 comprises much information, it is displayed at a slower speed than a segment of the stored part 202 comprising little information. For example, a dialogue between two people comprises much information and an impression of a landscape taking 5 minutes generally comprises little information. Based on the information in the stored part 202, the processing unit 111 subsequently defines a number of key frames which are displayed during the synchronization process. A relatively large number of key frames is chosen from a segment comprising much information and a relatively small number of key frames is chosen from a segment with little information. During the synchronization process, only the key frames are subsequently displayed.

In a further embodiment, the key frames are allocated in advance or during transmission by a content provider. In yet another embodiment, the stored part 202 consists of key frames only. This has the advantage that less space is required in the first memory 112.

In the described embodiments of the invention, the stored part 202 is locally stored in apparatus 110 in the first memory 112. However, it is also possible to store the stored part 202 in a third memory (not shown) with the content provider. During the synchronization period 260, only the key frames are presented via the input signal 115 to the system 100 for the purpose of display on display device 102.

An application in accordance with the MHP standard has been mentioned as an interruption in relation to the displayed embodiment of the invention. It will be evident to those skilled in the art that this may be alternatively a different application. In a further embodiment of the invention, the input signal is a standard analog high-frequency signal in accordance with the PAL or NTSC standard and the data comprising instructions which can be performed by a processing unit on applications is already available in the second memory 114 as from the manufacture of the apparatus 110, which second memory has a non-volatile character in this embodiment such as a battery-backed SRAM or an EEPROM memory. It is also possible that the interruption is generated by the user giving the apparatus 110 a command via the operating panel 104.

In summary, the invention relates to a method and apparatus (110) for receiving and displaying a stream of audiovisual information (200). During display of the stream of audiovisual information (200), the display may be interrupted by an application (220). This causes a user to miss part of the audiovisual information (200). It is therefore proposed to store the audiovisual information (200) during the application (220) and present the missed content (202) to the user after the interruption. The storage is automatically triggered by the start of the application (220). However, this causes a delay in the display of the audiovisual information (200). The user is offered the possibility to let the displayed stream of audiovisual information (210) catch up with the received audiovisual information (200). This catch-up may be performed automatically, triggered by the end of the application (220).

1. A method of displaying a received stream of audiovisual information (210) which is interrupted at a point of interruption (252) during display and in which the display of the stream of audiovisual information is resumed from the point of interruption (252) after the end of the interruption, characterized in that, after resuming the display of the stream of audiovisual information, the stream of audiovisual information (210) is displayed at an accelerated rate up to the point where the displayed stream of audiovisual information is synchronous with the received stream of audiovisual information, further referred to as point of synchronization (254).

2. A method as claimed in claim 1, characterized in that the accelerated display of the stream of audiovisual information (210) is effected automatically.

3. A method as claimed in claim 1, characterized in that, during accelerated display, the display speed is determined by the information density of the stream of audiovisual information (210).

4. A method as claimed in claim 1, in which the stream of audiovisual information (200) is built up of consecutive frames, characterized in that the accelerated display is effected by displaying key frames only.

5. A method as claimed in claim 4, characterized in that in time, the key frames are marked in the stream of audiovisual information (200) before transmission of the stream of audiovisual information (200).

6. A method as claimed in claim 4, characterized in that the key frames are chosen on the basis of the information density in the stream of audiovisual information (200).

7. A method as claimed in claim 4, in which the stream of audiovisual information is stored in the memory as from the point of interruption, characterized in that only the key frames are stored in the memory.

8. A method as claimed in claim 1, characterized in that the point of synchronization (254) is adjusted by the user.

9. An apparatus (110) adapted to receive a stream of audiovisual information (200) and to display said stream on a display device (102), the apparatus (110) being further adapted to interrupt the display at a point of interruption (252) during the display of the stream of audiovisual information (200), and to a resume the display of the stream of audiovisual information (200) from the point of interruption (252) after the end of the interruption, characterized in that, after resuming the display of the stream of audiovisual information (200), the apparatus (110) is further adapted to display the stream of audiovisual information (210) at an accelerated rate up to the point where the display of the stream of audiovisual information (210) is synchronous with the reception of the stream of audiovisual information (200), further referred to as point of synchronization (254).
